(19) United States
(12) Patent Application Publication
(10) Pub. No.: US 2012/0293653 A1
(43) Pub. Date: Nov. 22, 2012

(54) BASE STATION

(75) Inventor: Victor Schweikart, Subiaco (AU)

(73) Assignee: Technological Resources PTY Ltd., Melbourne, VIC (AU)

(21) Appl. No.: 13/390,007

(22) PCT Filed: Aug. 12, 2010
(86) PCT No.: PCT/AU2010/001032

§ 371 Date: Jul. 23, 2012

(30) Foreign Application Priority Data
Aug. 12, 2009 (AU) 2009903774

(51) Int. Cl. H04N 7/18

(52) U.S. Cl. 348/143; 348/E07.085

(57) ABSTRACT

A base station (10) for wireless communication with equipment on a mine operation (40). The base station (10) is moveable and comprises a wireless network interface (16) arranged to facilitate communications with a monitoring station (14) and with at least one item of mine equipment (12) so that at least one item of mine equipment is monitorable and/or controllable from the monitoring station (14) through the base station (10). The base station also includes a camera (20) arranged to capture images of an area of the mine operation (40) adjacent the base station. The base station (10) is arranged to communicate information indicative of the captured images to the monitoring station (14) through the wireless network interface (16).

### FIELD OF THE INVENTION

The present invention relates to a base station for facilitating wireless communications with mine equipment at a mine operation.

### BACKGROUND OF THE INVENTION

It is known to provide a mine operation such as a mine, site with a monitoring station arranged to facilitate control and/or monitoring of mine equipment by mining personnel. Such a monitoring station communicates with a plurality of mobile base stations each of which is arranged to communicate with a central monitoring station, for example using a wireless network. The base stations are movable so that the base stations may be maintained in range of mining equipment with which the base stations are required to communicate.

### SUMMARY OF THE INVENTION

In accordance with a first aspect of the present invention, there is provided a base station for wireless communication with equipment on a mine operation, the base station being moveable and comprising:

a wireless network interface arranged to facilitate communications with a monitoring station and with at least one item of mine equipment so that at least one item of mine equipment is monitorable and/or controllable from the monitoring station through the base station; and

a camera disposed on the base station and arranged to capture images of an area of the mine operation adjacent the base station;

the base station being arranged to communicate information indicative of the captured images to the monitoring station through the wireless network interface.

In one embodiment, the camera is arranged so as to facilitate modification of the magnification of the camera from the monitoring station.

In one embodiment, the base station comprises a motor arranged to facilitate selective movement of the camera, wherein the motor may be controllable from the monitoring station so that an operator disposed at the monitoring station is able to selectively control the position of the, camera.

The camera may be a video camera or a still camera.

In an embodiment wherein the camera is a video camera, the base station may be arranged to transmit video image data captured by the camera at varying frame rates dependent on movement activity within the image. The base station may be arranged to transmit video image data from the camera using adaptive frame rate technology wherein a frame rate of a video signal varies depending on differences in image data between various frames.

In one embodiment, the base station is arranged to communicate visual information received from the camera to the monitoring station on request, for example using a server.

In one embodiment, the base station is arranged to continuously stream visual information received from the camera to the monitoring station.

In one embodiment, the monitoring station is disposed at a mine operation and is in communication with the mine equipment through a wireless LAN. In an alternative embodiment, the monitoring station is disposed at a metropolitan location.

In one embodiment, the base station comprises an upwardly extending antenna and the camera is mounted on the antenna.

In one embodiment, the mine operation comprises at least one mine site, at least one port facility and/or at least one rail network.

In accordance with a second aspect of the present invention, there is provided a method of monitoring a mine operation, said method comprising:
providing a plurality of base stations moveable within the mine operation, each base station comprising:
   a wireless network interface arranged to facilitate communications with a monitoring station and with at least one item of mine equipment so that at least one item of mine equipment is monitorable and/or controllable from the monitoring station through the base station; and
   a camera disposed on the base station and arranged to capture images of an area of the mine operation adjacent the base station; disposing the base stations at selected locations around the mine operation;
capturing images from the cameras associated with the plurality of base stations; and
communicating information indicative of the captured images to the monitoring station through the respective wireless network interfaces.

In one embodiment, the method comprises periodically moving the base stations relative to the mine operation as mining activities at the mine operation change.

In one embodiment, the method comprises transmitting control signals for the cameras to the base stations from the monitoring station.

In one embodiment, the base stations are responsive to control signals received from the monitoring station, and the method comprises only transmitting images from the cameras in response to a control signal indicative of a request for image data received from the monitoring station.

In one embodiment, the method comprises transmitting video image data at varying frame rates depending on movement activity within the image.

In one embodiment, the method comprises transmitting video image data using adaptive frame rate technology wherein a frame rate of a video signal varies depending on differences in image data between various frames.

In one embodiment, the method comprises facilitating selective movement of the camera so as to modify the orientation of the camera from the monitoring station.

In one embodiment, the method comprises facilitating modification of the magnification of the camera from the monitoring station.

In accordance with a third aspect of the present invention, there is provided a moveable base station comprising:
a wireless network interface arranged to facilitate communications with a monitoring station; and
a camera disposed on the base station and arranged to capture images of an area of a mine operation adjacent the base station;
the base station being arranged to communicate information indicative of the captured images to the monitoring station through the wireless network interface.

### BRIEF DESCRIPTION OF THE DRAWINGS

The present invention will now be described, by way of example only, with reference to the accompanying drawings, in which:

FIG. 1 is a schematic block diagram of a base station according to an embodiment of the present invention;

FIG. 2 is a diagrammatic representation of the base station shown in FIG. 1; and

FIG. 3 is a conceptual diagram illustrating a mine operation including a plurality of base stations according to an embodiment of the present invention.

### DESCRIPTION OF AN EMBODIMENT OF THE INVENTION

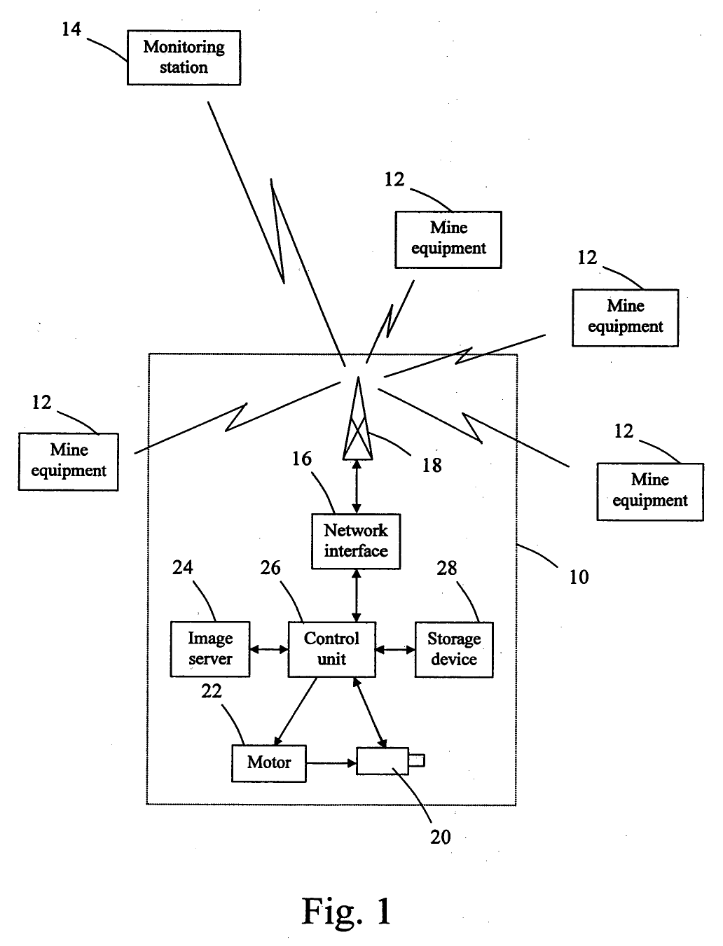

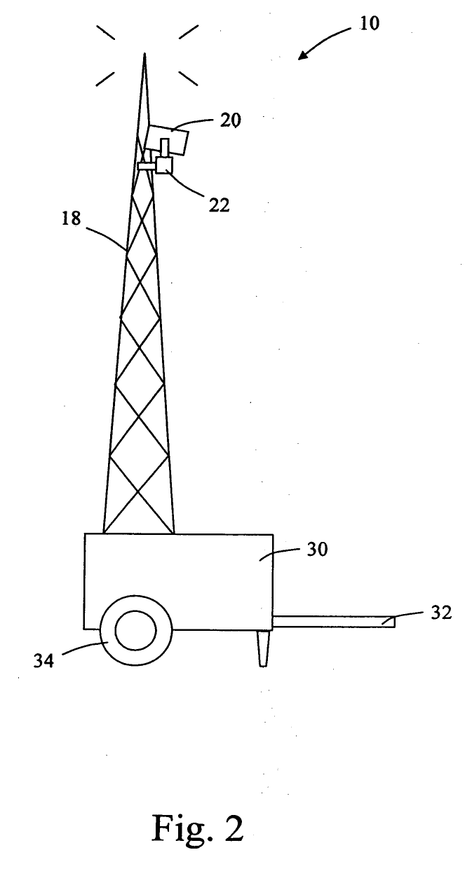

Referring to the drawings, in FIGS. 1 and 2 there is shown a base station 10 which is arranged to communicate wirelessly with mine plant and equipment 12 at a mine operation, for example so that operators may remotely monitor, activate, deactivate and/or control operation of plant and equipment. In this example, the mine operation is a mine site, although it will be understood that other mine operations are envisaged, such as a port facility or a rail facility, or any operation associated with extracting, handling, processing or transporting bulk commodities in a mining environment.

In this example, a plurality of base stations 10 are provided at the mine operation, with each base station 10 communicating wirelessly with one or more monitoring stations 14, in this example one monitoring station 14. The monitoring station 14 is used to wirelessly monitor, activate, deactivate and/or control operation of plant and equipment 12 at the mine operation.

In operation, each mine operation, in this example a mine site, has daily, weekly, monthly and annual schedules for mining of ore and waste. Transportation of ore from each of the mine sites to a port facility is scheduled according to the daily, weekly and monthly schedules of the various mine sites. A stock yard receives ore from the rail network at a train load-out facility which places the ore onto conveyors that in turn route the ore to a designated stock pile. The placement of ore onto the stockpiles is scheduled so that the ore from the various mine sites is blended to produce a uniform product prior to loading onto ships at the port facility. Alternately, the stock piles may be blended into various qualities of ores, such as high grade ore and low grade ore or ore with specific characteristics. Alternately, ore may be blended at each mine site prior to railing so that each mine site produces a specified average grade of ore that is then railed to the port facility. Under these conditions the ore is routed from the train load-out facility to a designated stock pile without further blending.

Plant and equipment at each mine operation are controlled from the monitoring station 14, which may be disposed locally or remotely relative to the mine operation.

The monitoring station 14 may be used to transmit operating commands to mobile and fixed plant and equipment 12 located at the mine operation via any suitable wireless communications network. The mobile and fixed plant and equipment 12 transmit operational data to the monitoring station 14 which in turn displays the operational data on display screens.

Each item of equipment 12 includes a mine equipment controller (not shown) which may be in the form of a programmable logic controller (PLC) to enable electronic monitoring and control of the mine equipment.

The equipment 12 may include crushers, screens, conveyor belts, stackers & reclaimers, train load-out facilities, mobile equipment including trucks and excavators, locomotives, track based signalling systems, points, wayside equipment and wayside signals, rail car unloading facilities, conveyor belts, stackers & reclaimers and ship loaders. However, it will be understood that any plant or equipment for use in a mine operation is envisaged.

The base station 10 includes a network interface 16 and an antenna 18 for enabling the base station 10 to communicate wirelessly with the equipment 12 and with the monitoring station 14. Each base station may provide a cell of a wireless cellular communications network with which mobile communications terminals communicate. As the mobile communications terminals move from location to location within the mine site there may be a hand over of communications from base station to base station. The base stations may provide a wireless local area network (LAN) within the mine site with which mobile communications terminals and mobile computer equipment within the mine site communicate.

The base station 10 also includes a camera 20 and a motor 22 arranged to facilitate selective movement of the camera 20 so that the camera is receiving a desired field of view. The camera is controllable from the monitoring station 14 so as to modify the magnification of the camera 20, and the motor 22 is controllable from the monitoring station 14 so that an operator disposed at the monitoring station 14 is able to selectively control the orientation of the camera 20.

In this example, the camera is a video camera, although it will be understood that other arrangements are possible, such as a still camera, a video camera or a camera capable of capturing both still images and video.

The base station 10 is arranged to communicate visual information received from the camera 20 to the monitoring station 14, in this example using a server 24 arranged to provide the monitoring station 14 with visual information on request. In one variation, the base station 10 is arranged to continuously stream the visual information to the monitoring station.

In an embodiment wherein the camera is a video camera, video image data may be transmitted at varying frame rates dependent on movement activity within the image, or the base station may be arranged to transmit only video data relating to portions of the captured image which change over time. The video image data may be transmitted using adaptive frame rate technology wherein the transmitted frame rate of a video signal varies depending on differences in image data between frames.

The base station 10 also includes a control unit 26 arranged to control and coordinate operations in the base station and, in particular, to control handling of image data received from the camera 20 and forwarding of the image data to the monitoring station 14. A storage device 28 is also provided for storing programs and data usable by the control unit 26 to implement the functionality of the base station 10.

The base station 10 generally includes a plurality of electrochemical cells arranged to form an electrical battery for powering respective electrical components comprising the base station. The base station may include solar cells configured for recharging the battery. The base station 10 may further include electrical power management circuitry, typically as part of the control unit 26, for controlling and regulating the supply of available electrical energy to the respective components. For example, such power management circuitry may be configured to divert electrical energy to specific components only when sufficient energy is available from the solar cells.

In one embodiment, the power management circuitry is configured to supply the camera with electrical energy only when sufficient energy is available from the solar cells, i.e. the camera is generally only powered during daylight hours. In such an example, the power management circuitry is configured to supply the wireless network interface both from the solar cells, when available, as well as the battery when the solar cells are inactive, i.e. during the night.

In this example, the monitoring station is disposed at a mine operation and is in communication with the mine equipment 12 through a wireless LAN. However, it will be understood that other arrangements are possible. For example, the monitoring station may be disposed at a location remote from the mine operation, such as at a central monitoring facility, for example disposed at a metropolitan location.

Referring to FIG. 2, an example base station 10 is shown, the network interface 16, the server 24, the control unit 26 and the storage device 28 of the base station 10 being disposed in a housing 30 and the antenna 18 extending upwardly of the housing 30. The motor 22 and the camera 20 are mounted on the antenna 18 at a remote end of the antenna 18 so that the camera has a good view of the surrounding area. The base station 10 also includes a tow bar 32 and wheels 34 to enable the base station to be easily transported around the mine operation.

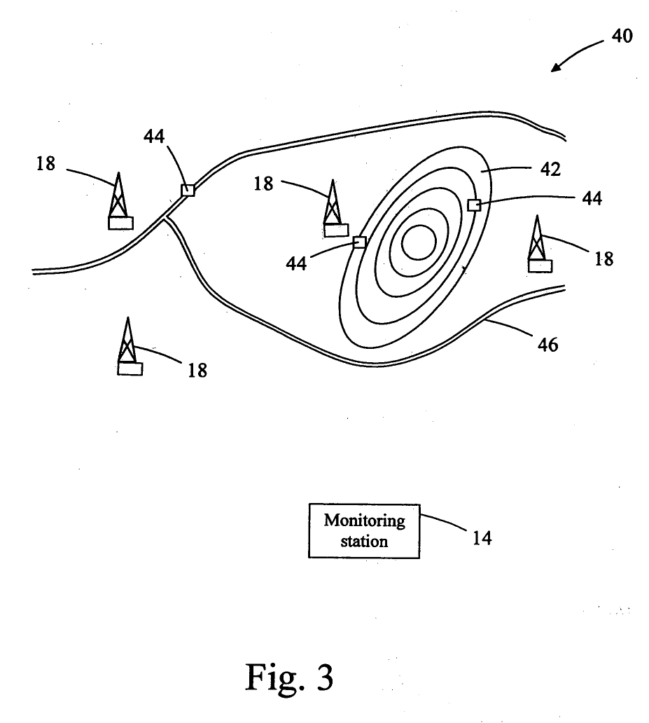

Referring to FIG. 3, an example mine operation 40 is shown which in this example is a mine site. The mine site 40 includes an open pit mine 42 and several transportation routes 46 on which for example trucks 44 travel when transporting ore around the mine site 40. Several base stations 10 are distributed around the mine site for communication with mobile and fixed plant and equipment undertaking mining activities. Locating a camera on a base station helps to ensure that areas of the mine site where mining activities are current are generally always viewable at the monitoring station 14. It will be understood that as mine operations progress and the mined areas develop, the base stations 10 may be moved to more appropriate locations in order that communications with mobile and fixed plant and equipment can be maintained. Locating cameras on these base stations helps to ensure that operators disposed at the monitoring station 14 are generally always able to view areas of the mine site 40 where mining activities are being undertaken. The operators may also modify the field of view and magnification of the cameras 20 by controlling the respective motors 22 from the monitoring station 14.

It will also be appreciated that by disposing the base stations at appropriate locations, both objectives of ensuring good communications with the equipment 12 and with the monitoring station 14, and obtaining a view of the mine site at desired areas can be obtained.

Modifications and variations as would be apparent to a skilled addressee are deemed to be within the scope of the present invention.

1. A base station for wireless communication with equipment on a mine operation, the base station being moveable and comprising:
a wireless network interface arranged to facilitate communications with a monitoring station and with at least one item of mine equipment so that the at least one item of mine equipment is monitorable and/or controllable from the monitoring station through the base station; and
a camera arranged to capture images of an area of the mine operation adjacent the base station;
the base station being arranged to communicate information indicative of the captured images to the monitoring station through the wireless network interface.

2. A base station as claimed in claim 1, wherein the camera is arranged so as to facilitate modification of the magnification of the camera from the monitoring station.

3. A base station as claimed in claim 1, further comprising a motor arranged to facilitate selective movement of the camera, wherein the motor is controllable from the monitoring station so that an operator disposed at the monitoring station is able to selectively control the orientation of the camera.

4. A base station as claimed in claim 1, wherein the camera is a video camera.

5. A base station as claimed in claim 4, wherein the base station is arranged to transmit video image data captured by the camera at varying frame rates dependent on movement activity within the image.

6. A base station as claimed in claim 5, wherein the base station is arranged to transmit video image data from the camera using adaptive frame rate technology wherein a frame rate of a video signal varies depending on differences in image data between various frames.

7. A base station as claimed in claim 1, wherein the camera is a still camera.

8. A base station as claimed in claim 1, wherein the base station is arranged to communicate visual information received from the camera to the monitoring station on request.

9. A base station as claimed in claim 1, wherein the base station is arranged to continuously stream visual information received from the camera to the monitoring station.

10. A base station as claimed in claim 1, wherein the base station is arranged to communicate visual information received from the camera to the monitoring station using a server.

11. A base station as claimed in claim 1, wherein the monitoring station is disposed at a mine operation and is in communication with the at least one item of mine equipment through a wireless LAN.

12. A base station as claimed in claim 1, wherein the monitoring station is disposed at a metropolitan location.

13. A base station as claimed in claim 1, wherein the base station comprises an upwardly extending antenna and the camera is mounted on the antenna.

14. A base station as claimed in claim 1, wherein the mine operation comprises at least one mine site, at least one port facility and/or at lest one rail network.

15. A method of monitoring a mine operation, said method comprising:
providing a plurality of base stations moveable within the mine operation, each base station comprising:
a wireless network interface arranged to facilitate communications with a monitoring station and with at least one item of mine equipment so that the at least one item of mine equipment is monitorable and/or controllable from the monitoring station through the base station; and
a camera arranged to capture images of an area of the mine operation adjacent the base station;
disposing the plurality of base stations at selected locations around the mine operation;
capturing images from the cameras associated with the plurality of base stations; and
communicating information indicative of the captured images to the monitoring station through the respective wireless network interfaces.

16. A method as claimed in claim 15, further comprising periodically moving the base stations relative to the mine operation as mining activities at the mine operation change.

17. A method as claimed in claim 15, further comprising transmitting control signals for the cameras to the base stations from the monitoring station.

18. A method as claimed in claim 15, further comprising only transmitting images from the cameras in response to a request for image data received from the monitoring station.

19. A method as claimed in claim 15, further comprising continuously streaming visual information received from the camera to the monitoring station.

20. A method as claimed in claim 15, wherein the camera is a video camera.

21. A method as claimed in claim 20, further comprising transmitting video image data at varying frame rates depending on movement activity within the image.

22. A method as claimed claim 21, further comprising transmitting video image data using adaptive frame rate technology wherein a frame rate of a video signal varies depending on differences in image data between various frames.

23. A method as claimed in claim 15, wherein the camera is a still camera.

24. A method as claimed in claim 15, further comprising facilitating selective movement of the camera so as to modify orientation of the camera.

25. A method as claimed in claim 15, further comprising facilitating modification of the magnification of the camera from the monitoring station.

26. A moveable base station comprising:
a wireless network interface arranged to facilitate communications with a monitoring station; and
a camera arranged to capture images of an area of a mine operation adjacent the base station;
the base station being arranged to communicate information indicative of the captured images to the monitoring station through the wireless network interface.

27. (canceled)

28. (canceled)
